(19) United States
(12) Patent Application Publication
(10) Pub. No.: US 2014/0357175 A1
(43) Pub. Date: Dec. 4, 2014

(54) Multi-Platform Game Hoist

(71) Applicants: John A. Woller, JR., Decatur, AL (US); John A. Woller, Decatur, AL (US); Ronald R. Woller, Decatur, AL (US)

(72) Inventors: John A. Woller, JR., Decatur, AL (US); John A. Woller, Decatur, AL (US); Ronald R. Woller, Decatur, AL (US)

(21) Appl. No.: 14/290,158

(22) Filed: May 29, 2014

Related U.S. Application Data
(60) Provisional application No. 61/829,641, filed on May 31, 2013.

(51) Int. Cl. A22B 5/06

(52) U.S. Cl. CPC A22B 5/06
USPC 452/187

(57) ABSTRACT

In one aspect, the present disclosure provides a multi-platform game hoist 10 comprising a base member 20, a lower boom 60, an upper boom 90 and a means for attaching game 150. In a second aspect, the present disclosure provides a multi-platform game hoist 10 comprising a hitch adapter 160, a lower boom 60, an upper boom 90 and a means for attaching game 150, in yet a third aspect, the present disclosure provides a multi-platform game hoist 10 comprising a lower boom 60 configured to engage either a base member 20 or a hitch adapter 160.

### CROSS REFERENCE TO RELATED APPLICATIONS

This application claims priority to, and the benefit of, pending U.S. Provisional Application Ser. No. 61,829,641 filed on May 31, 2013 titled “Multi-Platform Game Hoist.”

### FIELD OF THE DISCLOSURE

The present disclosure relates to a device suitable for hoisting and securing game for processing. More specifically, the present disclosure relates to a multi-platform game hoist that can be used as a standalone hoist or attached to a vehicle.

### BACKGROUND

Game hoists have been known in the art for a number of years. In particular, game hoists are used by hunters to allow them to process animals that have been harvested during a hunt as it is desirable to perform certain processing functions within a short period of time after harvest. Generally, there are two (2) types of game hoists known in the art, standalone versions and hitch mount versions. The standalone version is designed to sit on the ground (or other suitably flat surface) and allow the harvested game to be raised and then processed. The hitch mount version is designed to attach to the hitch mount of a vehicle (such as a truck) and allow the game to be raised and then processed. However, there is not a game hoist in the prior art that was designed to be a multi-platform hoist in that it could be used in similar manner to standalone hoists or hitch mounted hoists as the situation warranted. Such a multi-platform hoist is disclosed herein.

### BRIEF DESCRIPTION OF THE DRAWINGS

To further describe advantages and features of the present disclosure, a more particular description of the invention will be rendered by reference to specific embodiments thereof which are illustrated in the appended drawings. The drawings are not necessarily to scale, emphasis instead being placed upon illustrating the principles of the invention. It is to be appreciated that these drawings are not to be considered limiting in scope. The invention will be described and explained with additional specificity and detail through the use of the accompanying drawings in which:

FIG. 1 depicts an example of the multi-platform game hoist 10 disclosed herein in a standalone configuration.

FIG. 2 depicts an example of the multi-platform game hoist 10 disclosed herein in a hitch mount configuration.

FIGS. 3A-3C depict an example of the base member 30 disclosed herein.

FIG. 4 depicts an example of the lower boom 40 disclosed herein.

FIGS. 5A and 5B depict an example of the upper boom 90 disclosed herein.

FIG. 6 depicts an example of the hitch adapter 160 disclosed herein.

### SUMMARY

In one aspect, the present disclosure provides a multi-platform game hoist 10 comprising a base member 20, a to boom 60, an upper boom 90 and a means for attaching game 150. In a second aspect, the present disclosure provides a multi-platform game hoist 10 comprising a hitch adapter 160, a lower boom 60, an upper boom 90 and a means for attaching game 150. In yet a third aspect, the present disclosure provides a multi-platform game hoist 10 comprising a lower boom 60 configured to engage either a base member 20 or a hitch adapter 160.

### DETAILED DESCRIPTION

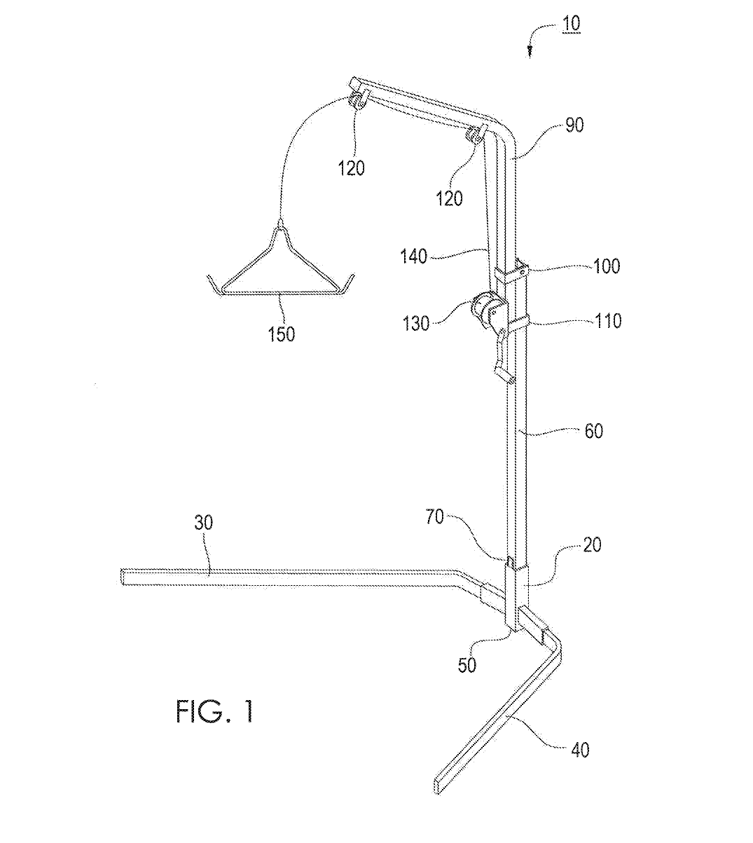

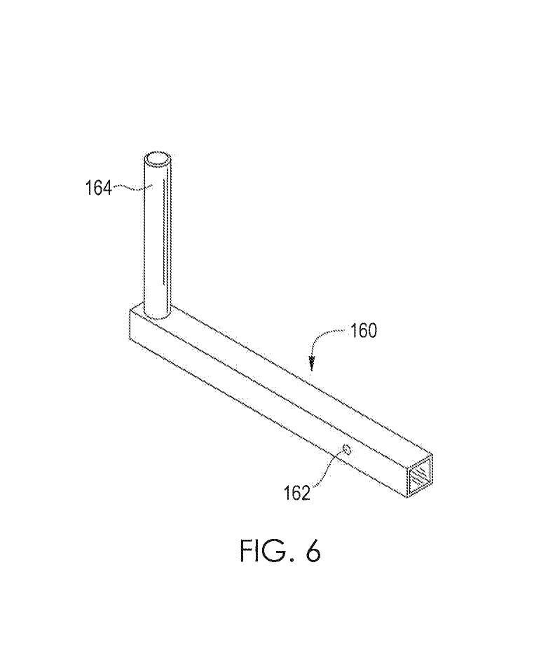

The present invention is depicted in FIGS. 1-6. Turning to FIGS. 1, 3A-3C, 4 and 5A-5B, the multi-platform game hoist 10 comprises the base member 20, the lower boom 60, the upper boom 90 and the means for attaching game 150.

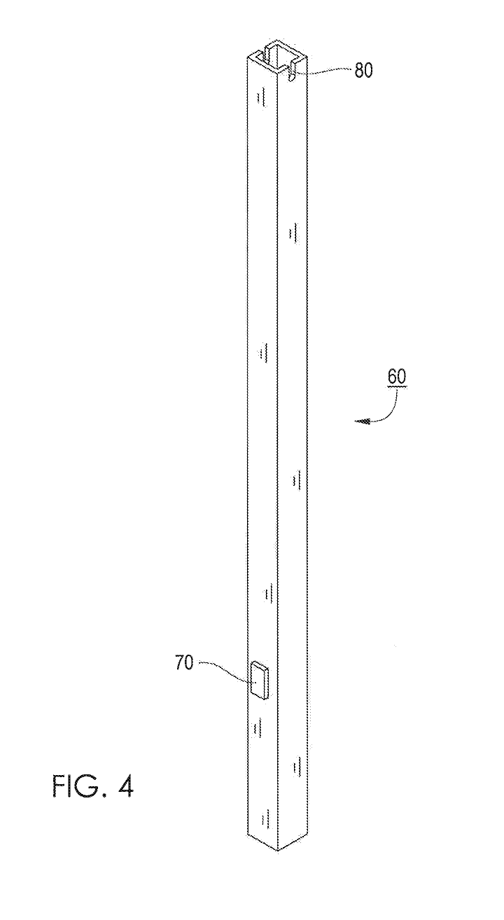

As shown in FIGS. 1 and 4, the multi-platform game hoist 10 includes a lower boom 60 which slidingly engages with either the base member 20 or the hitch adapter 160 (as described herein) at one end and contacts the upper boom 90 on the other end. The lower boom assembly 60 comprises a stop 70 and a slot 80 as shown in FIG. 4. The stop 70 is attached to the lower portion of the outer surface of the lower boom 70 and is used to position the lower boom 60 relative the base member 20 if the multiplatform game hoist 10 is used with the base member 20. The slot 80 is positioned on the upper end of the lower boom 60 opposite the stop 70 and is configured to receive a bar 102 which comprises part of the upper attachment means 100 of the upper boom 90.

In one embodiment, as shown in FIG. 4, the lower boom 60 is generally tubular in construction wherein a central cavity is defined by the outer walls of the lower boom 60. The central cavity may extend the length of the lower boom 60 or only a portion of the length of the lower boom 60. In one embodiment, the lower boom 60 is of a rectangular tubular construction wherein the central cavity is defined by four (4) walls and the central cavity further comprises an opening on the end of the lower boom 60 closest to the stop 70 and extends at least a portion of the length of the lower boom 60.

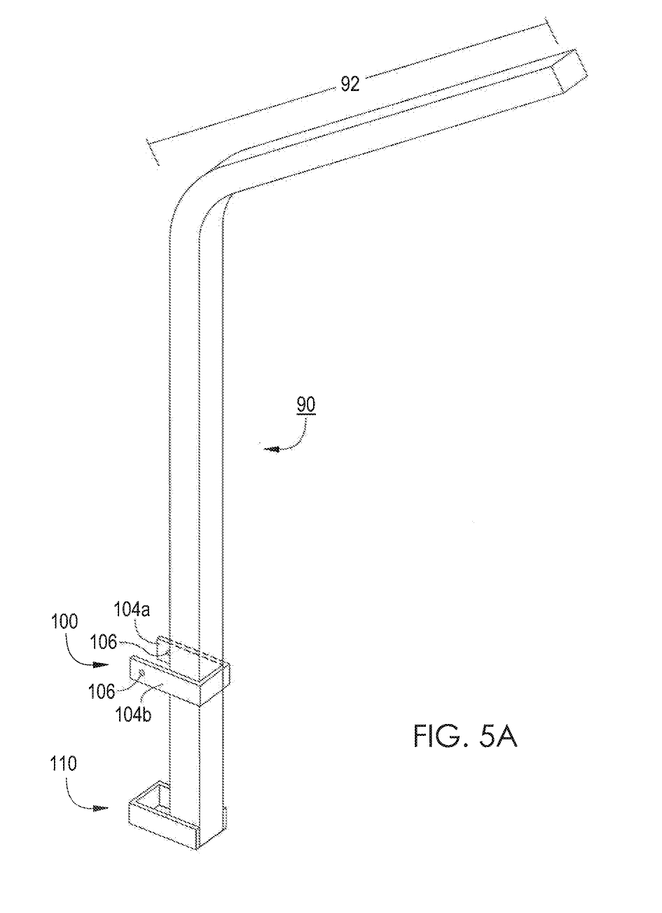

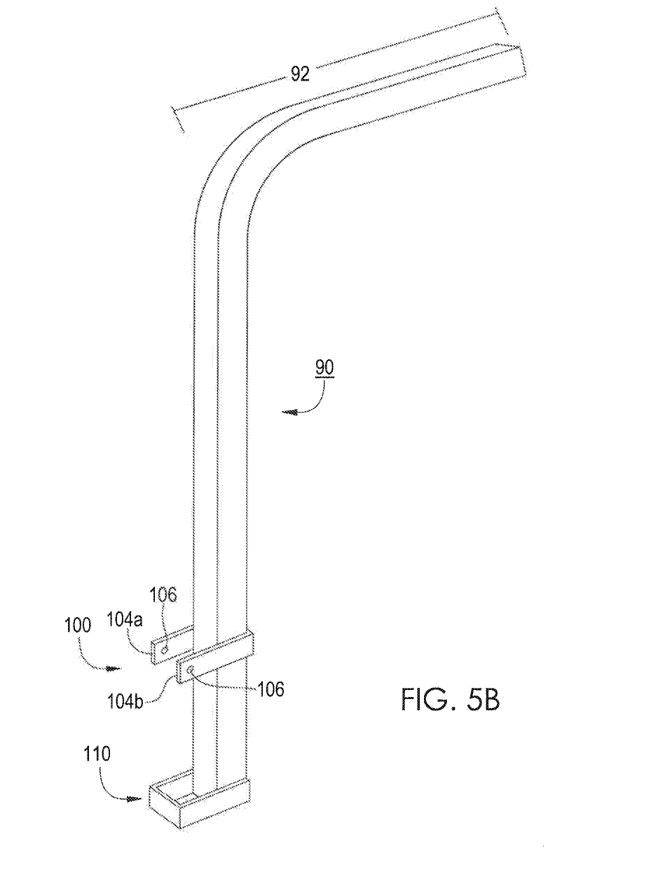

Now turning to FIGS. 1 and 5A-5B, the upper boom 90 comprises an upper attachment means 100, a lower attachment means 110, a plurality of pulleys 120 and a wench 130 which has a cable 140 wound about it and fed through the plurality of pulleys 120.

The upper boom 90 attaches to the lower boom 60 through the upper attachment means 100 and the lower attachment means 110. The upper attachment means 110 comprises a bar 102 spanning between two (2) plates 104a, 104b located opposite one another. Generally, the plates 104a, 104b extend rearwardly from the upper boom 90 and further comprise a hole 106 through which the bar 102 is inserted. The bar 102 then contacts the bottom of the slot 80 of the lower boom 60 as the upper boom 90 is slid proximate to the lower boom 60 along the longitudinal axis of the lower boom 60.

The lower attachment means 110 comprises a guiding means to guide the upper boom 90 as it is slid downwardly along the longitudinal axis of the lower boom 60. In one embodiment, this guiding means comprises a bracket that extends rearwardly of the upper boom 90 and is of sufficient size to encompass the perimeter of the lower boom 60.

In the embodiment shown in FIGS. 5A and 5B, the upper boom 90 is of a generally tubular construction. In a preferred embodiment, the upper boom 90 is of a rectangular tubular construction defined by four (4) walls. The upper boom 90 further comprises an arm 92 extending outwardly therefrom from which the cable 140 extends. In one embodiment, the arm 92 is formed by the curvature of the upper portion of the upper boom 90 and is integral to the upper boom 90. Of course, the arm 92 could also be formed by the addition of a separate piece of material to the upper boom 90 and the arm 92 need not be at any particular angle relative to the upper boom 90.

The upper boom 90 further comprises a plurality of pulleys 120 and a wench 130. Generally, the plurality of pulleys 120 and the wench 130 are located on the opposite side of the upper boom 90 than plates 104a, 104b and bolt 102 of the upper attachment means 100 and the bracket of the lower attachment means 110. The wench 130 has a handle, a series of gears and a cable 140 wound around a drum wherein the cable 140 is fed through the plurality of pulleys 120 and attaches to a means for attaching game 150. The wench 130 acts upon the cable 140 to raise or lower the game to be processed.

The means for attaching the game 150 is attached to one end of the cable 140 using any means known to one of ordinary skill in the art. In one embodiment, the means for attaching game 150 is a gambrel. Of course, other means should be considered within the scope of this disclosure including without limitation one or more hooks.

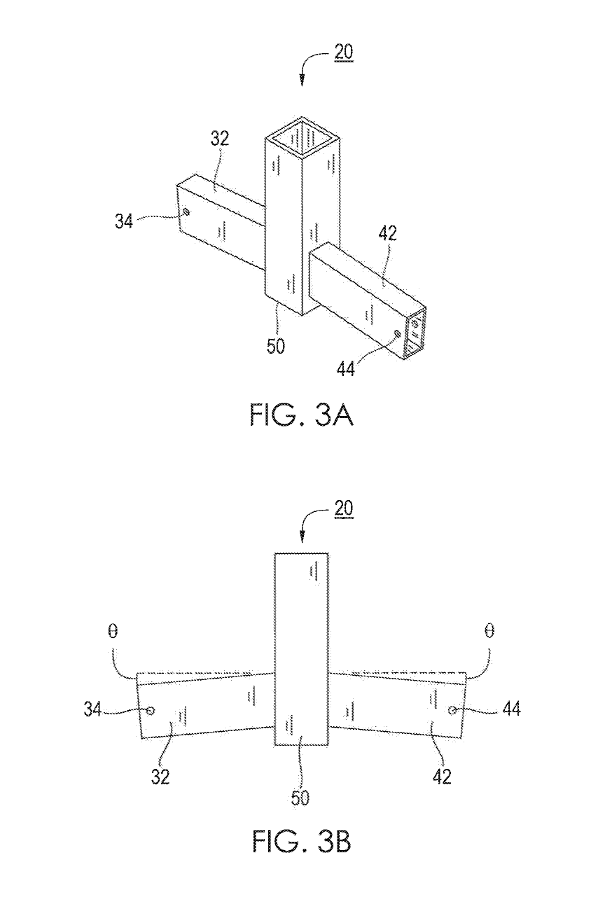

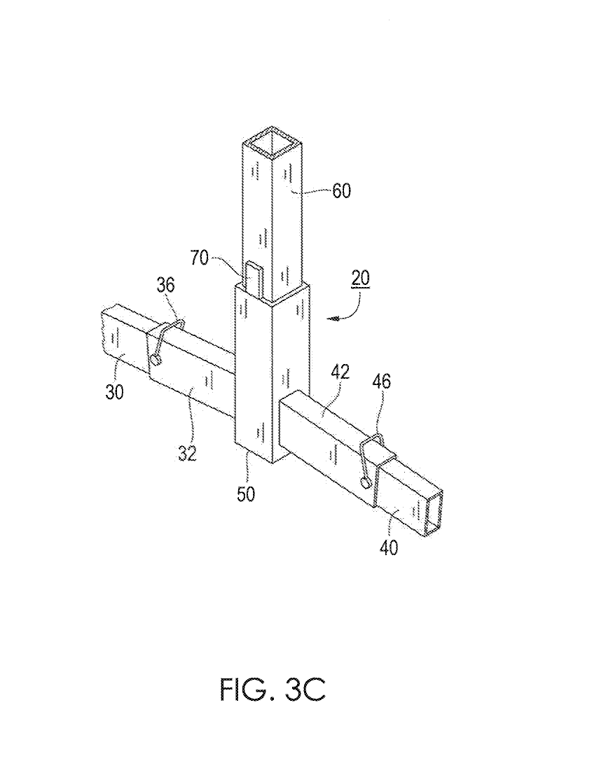

In one embodiment shown in FIGS. 1 and 3A-3C, the multi-purpose game hoist 10 is used in a standalone configuration with a base member 20. The base member 20 is configured to sit upon a solid surface and slidingly engages the lower boom assembly 60 via a lower boom receiving opening 22.

The base member 20 comprises a first leg 30 extending therefrom and a second leg 40 extending therefrom. Generally, the first leg 30 and the second leg 40 extend outwardly from the base member 20 to create a wide base which provides support, balance and strength to the multi-platform game hoist 10 while in storage or use.

The first leg 30 and the second leg 40 slidingly engage the base member 20 via a first leg receiving element 32 and a second leg receiving element 42. The first leg receiving element 32 and the second leg receiving element 42 attach to the base member 20 at a less than perpendicular angle ⊖ as shown in FIG. 3B. In one embodiment, the first leg receiving element 32 and the second leg receiving element 42 attach to the base member at an angle ⊖ that is approximately three (3) degrees shy of perpendicular. The angle of attachment of the first leg receiving element 32 and the second leg receiving element 42 provide a stronger and more stable position for the multiplatform game hoist 10 while in use or storage.

The first leg 30 further comprises a hole that is configured to receive a fastener as shown in FIG. 3C. As the first leg 30 is slid into the first leg receiving element 32, the hole on the leg will align with a hole 34 on the first leg receiving element 32. Once that alignment has occurred, a fastener 36 may be inserted through the hole 34 on the first leg receiving element 32 and the hole on the first leg 30 thereby reversibly securing the first leg 30 to the base member 20. A similar procedure can be used to secure the second leg 40 to the base member 20 using hole 44 on the second leg securing element 42.

The base member 20 further comprises an extending element 50 that generally extends downwardly from the base member 20 and contacts the surface upon which the base member 20 is placed. In one embodiment (shown in FIGS. 3A-3C), the extended element 50 is positioned between the first leg receiving element 32 and the second leg receiving element 42. The extended element 50 in combination with the first leg receiving element 32 and the second leg receiving element 42 cause the multi-platform game hoist 10 to tilt forward and apply pressure to the wide base created by the first leg 30 and second leg 40 thereby stabilizing the multi-platform game hoist 10 when in storage or use

The lower boom assembly 60 (described in detail above) is positioned in the lower boom receiving opening 22 of the base member 20 via a stop 70 located on the lower boom assembly that contacts the base member 20. As the lower boom assembly 60 is slid into the lower boom receiving opening 22, the stop 70 will eventually rest against the base member 20 thereby preventing the lower boom 60 from being slid further into the lower boom receiving opening 22.

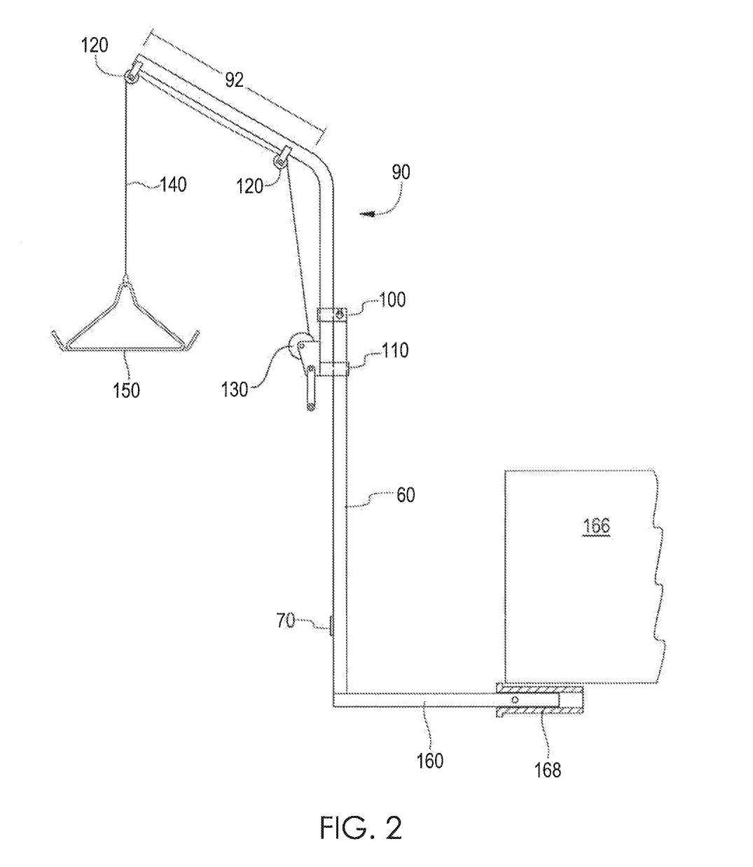

Now referring to FIGS. 2, 4, 5A-5B and 6, in an alternate embodiment, the multi-platform game hoist 10 is used with a hitch adapter 160. The hitch adapter 160 is designed to allow the multi-platform game hoist 10 to be mounted to a vehicle 166 (such as a truck) In one embodiment, the hitch adapter 160 is insertable into a conventional box beam trailer hitch pipe 168 of the vehicle 166. The hitch adapter includes a hole 162 to receiving a locking member (such as a pin) which can be inserted through the hitch pipe 168 and the hitch adapter 162 and locked into place, The hitch adapter 162 further comprises a vertical shaft 164 located on the end of the hitch adapter 162 opposite the hole 162. The vertical shaft is configured to insert into the void created by the tubular construction of the lower boom 60. The vertical shaft 164 allows the lower boom 60 to rotate freely relative to the vehicle thus allowing the multi-platform game hoist to be used at a variety of angles relative to the vehicle.

The multi-platform game hoist 10 is easy to assemble, First, a user must decide if the base member 20 or hitch adapter 160 is desired. If the base member 20 is desired, the user would insert the first leg 30 and second leg 40 into the base member 20 as described herein and place the base member 20 on a solid and level surface. Next, the lower boom assembly 60 is slid into the base member 20 until the stop 70 is engaged. Next, the upper boom assembly 90 is slid into place on top of the lower boom 60 until the bar 102 of the lower attachment means contacts the bottom of the slot 80 on the lower boom 60.

If the user desires to mount the multi-platform game hoist 10 to a vehicle, the hitch adapter 160 is inserted and secured to the hitch pipe 168 of the vehicle 166. Next, the lower boom 60 is lowered onto the shaft 164. Finally, as above, the upper boom assembly 90 is slid into place on top of the lower boom 60 until the bar 102 of the lower attachment means contacts the bottom of the slot on the lower boom 60. The lower boom 60/upper boom 90 assembly is freely rotatable about the shaft 164.

The multi-platform game hoist 10 of the present disclosure provides many improvements over the prior art, including without limitation:
Allowing a hunter to use the same lower boom 60 and upper boom 90 with either a base member 20 or a hitch mount 160;
Being easy to assemble and disassemble; and
Incorporates a shorter upper boom 90 section to help alleviate some of the bending and torque imposed on the structure, which is designed to handle game animals easily

While the invention has been described with respect to a limited number of embodiments, those skilled in the art, having benefit of this disclosure, will appreciate that other embodiments can be devised which do not depart from the scope of the invention as disclosed here.

We claim:

1. A multi-platform game hoist comprising:
a. a lower boom,
b. an upper boom,
wherein the lower boom is configured to be interchangeably attachable to either a base member or a hitch adapter.

2. The multi-platform game hoist of claim 1 wherein the lower boom further comprises a stop located on an outer surface of a lower portion of the lower boom, wherein the stop engages an outer surface of the base member.

3. The multi-platform game hoist of claim 2 wherein the base member comprises a plurality of outwardly extending legs.

4. The multi-platform game hoist of claim 3, wherein the plurality of legs are reversibly connected to the base member.

5. The multi-platform game hoist of claim 4, wherein the legs connect to the base member at an angle that is less than perpendicular to a horizontal axis passing through the center of the base member.

6. The multi-platform game hoist of claim 2 wherein the lower boom slidably engages the base member.

7. The multi-platform game hoist of claim 6 wherein the upper boom further comprises an arm extending away from a vertical axis of the upper boom, wherein the arm is formed by the curverture of an upper portion of the upper boom.

8. The multi-platform game hoist of claim 7 wherein the arm is integral to the upper boom.

9. The multi-platform game hoist of claim 8, wherein the upper boom comprises upper and lower attachment means and wherein the lower boom and the upper boom are reversibly attached to one another via the upper and lower attachment means

10. A game hoist comprising:
a. a base member comprising a protrusion that extends outwardly from a lower surface of the base member,
b. a lower boom,
c. an upper boom comprising an upper and lower attachment means, and
d. a means for attaching game;
wherein the lower boom and the upper boom are reversibly attached to one another via the upper and lower attachment means.

11. The game hoist of claim 10 wherein the base member comprises a plurality of outwardly extending legs.

12. The game hoist of claim 10 wherein the lower boom slidably engages the base member.

13. The game hoist of claim 10 wherein the upper boom further comprises an arm extending away from a vertical axis of the upper boom, wherein the arm is formed by the curverture of an upper portion of the upper boom.

14. The game hoist of claim 10 wherein the arm is integral to the upper boom.

15. The game hoist of claim 11, wherein the plurality of legs are reversibly connected to the base member.

16. The game hoist of claim 15, wherein the legs connect to the base member at an angle that is less than perpendicular to a horizontal axis passing through the center of the base member.

17. A game hoist comprising:
a. a hitch adapter configured to mount to a vehicle's trailer hitch pipe;
b. a lower boom,
c. an upper boom comprising an upper and lower attachment means,
wherein the lower boom and the upper boom are reversibly attached to one another via the upper and lower attachment means.

18. The game hoist of claim 17 wherein the lower boom slidably engages the base member.

19. The game hoist of claim 18 wherein the upper boom further comprises an arm extending away from a vertical axis of the upper boom, wherein the arm is formed by the curvature of an upper portion of the upper boom.

20. The game hoist of claim 19 wherein the arm is integral to the upper boom.
